(19) United States
(12) Patent Application Publication
(10) Pub. No.: US 2020/0207243 A1
(43) Pub. Date: Jul. 2, 2020

(54) VENTILATED SEAT WITH INTEGRAL AIR PASSAGES

(71) Applicant: Lear Corporation, Southfield, MI (US)

(72) Inventors: Steve Rogers, Highland, MI (US); Jose Ebrado, JR., Lapu-Lapu City (PH); Kyle Smith, Beverly Hills, MI (US)

(73) Assignee: Lear Corporation, Southfield, MI (US)

(21) Appl. No.: 16/233,619

(22) Filed: Dec. 27, 2018

(51) Int. Cl. B60N 2/56

(52) U.S. Cl. CPC B60N 2/5642; B60N 2/5657

(57) ABSTRACT

A ventilated seat includes a cushion with an air channel extending from a cushion B-side. The ventilated seat also includes a spacer that defines one or more air passages. The air passages are connected to the air channel and to one or more air distribution holes on a cushion A-side. The ventilated seat further includes a cover layer located between the spacer and the cushion A-side. The cover layer is made of a foam material while the spacer is made of a different material and the cover layer and the spacer are a foam with integrated air passages.

### BACKGROUND OF THE INVENTION

This invention relates to a ventilated seat. More specifically, this invention relates to a foam seat with integrally molded air flow channels.

Some conventional vehicle seats include climate control features for the comfort of an occupant. A typical ventilated vehicle seat uses a blower to move air past the occupant. The moving air can increase evaporation and help cool the occupant. Heating elements or cooling elements may be included in order to provide conditioned air to further increase the comfort of the occupant.

The blower on the ventilated seat may operate as a push device or as a pull device. When the blower pushes air, it draws in air from the environment, usually from below or behind the ventilated seat. The blower then pushes the air through an air channel through the ventilated seat to an A-surface of the seat where the occupant is seated. The air is moved out through the A-surface and past the occupant. When the blower pulls air, it draws air in through the A-surface past the occupant. The air is then pulled through the air channel and expelled out into the environment, usually below or behind the ventilated seat.

The ventilated seat typically includes an air distribution system on the A-surface. The air distribution system allows the air to be moved across an enlarged area on the A-surface. This prevents the occupant from experiencing the air current as a concentrated flow on one location of their body. Also, by allowing the air current to flow through the enlarged area, the occupant is less likely to completely obstruct the air current when they are seated on the A-surface.

The ventilated seat normally includes a molded seat foam that supports the occupant. The typical air distribution system includes an insert that is placed into a cavity defined by the seat foam. Because the air distribution system is located on the A-surface of the ventilated seat, it will support some of the weight of the occupant. The insert will normally include a spacer material that maintains open air paths even when supporting the weight of the occupant. The blower is then able to move air through the A-surface, through the air paths around the spacer material, and through the air channel, even when the ventilated seat is occupied.

The foam of the ventilated seat is typically a closed-cell foam that comfortably supports the occupant. Because the insert is made of a different material from the foam, its presence can be discerned by an occupant of the ventilated seat. It would be desirable to have an alternative air distribution system for a ventilated seat.

### SUMMARY OF THE INVENTION

This invention relates to a ventilated seat. The ventilated seat includes a cushion with an air channel extending from a cushion B-side. The ventilated seat also includes a spacer that defines one or more air passages. The air passages are connected to the air channel and to one or more air distribution holes on a cushion A-side. The ventilated seat further includes a cover layer located between the spacer and the cushion A-side. The cover layer is made of a foam material, while the spacer is made of a different material. The cover layer and the spacer are a foam with integrated air passages

This invention also relates to a method of making a ventilated seat. The method includes positioning a spacer in a mold to create a foam space adjacent to the spacer. The spacer defines one or more air passages. The method also includes filling the foam space with a foam material to create a foam with integral air passages.

Various aspects of this invention will become apparent to those skilled in the art from the following detailed description of the preferred embodiments, when read in light of the accompanying drawings.

### BRIEF DESCRIPTION OF THE DRAWINGS

FIG. 1 is a perspective view of a ventilated seat.

FIG. 2 is an enlarged cut-away view of a seat cushion from the ventilated seat.

FIG. 3 is a top view of an insert from the seat cushion.

FIG. 4 is a bottom view of the insert.

FIG. 5 is a cross-sectional view of a portion of the ventilated seat taken along the line 5-5 of FIG. 1.

FIG. 6 is a cross-sectional view of two spacers from the insert positioned in a tray.

FIG. 7 is a view similar to FIG. 6, illustrating the tray located in a foam tool.

FIG. 8 is a view similar to FIG. 7, illustrating a foam added to the tool.

FIG. 9 is a view similar to FIG. 8, illustrating a complete foam with integral air passages.

FIG. 10 is a cross-sectional view of an alternative foam with integral air passages.

### DETAILED DESCRIPTION OF THE PREFERRED EMBODIMENTS

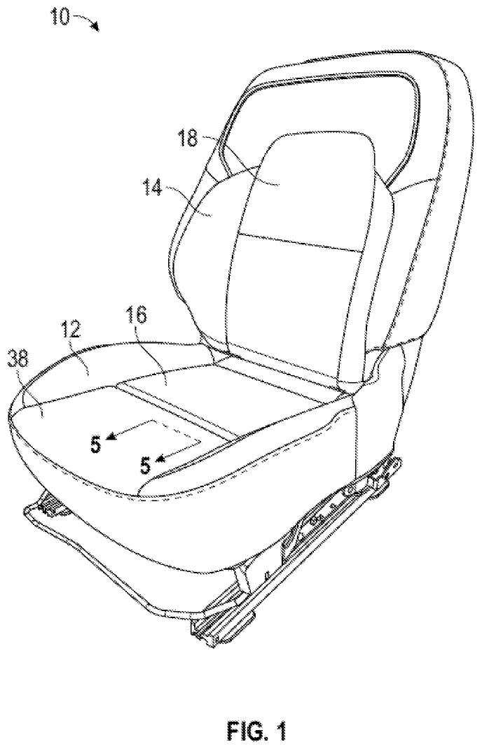

Referring now to the drawings, there is illustrated in FIG. 1 a perspective view of a ventilated seat, indicated generally at 10. The illustrated ventilated seat 10 is a vehicle seat that is adapted for use in a vehicle, such as a passenger car. However, the ventilated seat 10 may be any desired type of seat.

The ventilated seat 10 includes a seat cushion 12 and a seat back 14. The seat cushion 12 includes a cushion trim 16, and the seat back 14 includes a back trim 18. The illustrated cushion trim 16 and back trim 18 are made of cloth fabric and leather, but the cushion trim 16 and the back trim 18 may be made of any desired materials.

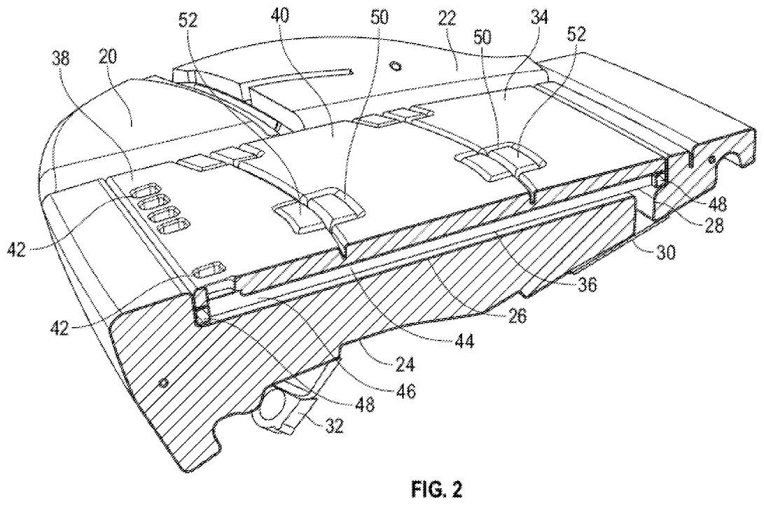

Referring to FIG. 2, there is illustrated an enlarged, cut-away view of the seat cushion 12. The cushion trim 16 is not shown in FIG. 2 so that underlying parts of the ventilated seat are visible. The ventilated seat 10 includes a cushion foam 20. The illustrated cushion foam 20 is a molded closed-cell foam, but may be made of any desired material and by any desired process. The cushion foam 20 provides comfort and support for an occupant (not shown) of the ventilated seat 10. The cushion foam 20 includes a cushion A-side 22, which is the side of the cushion foam 20 that normally faces the occupant, and an opposed cushion B-side 24. The cushion foam 20 is supported by a cushion frame (not shown), as is known in the art.

The seat cushion 12 includes a cavity 26 on the cushion A-side 22. The cavity 26 is recessed area that is defined in the cushion A-side 22 of the cushion foam 20. The illustrated cavity 26 is created during the molding of the cushion foam 20 by excluding foam from the area of the cavity 26. However, the cavity 26 may be created by any desired method. One or more air channels 28 extend from the cavity 26 to the cushion B-side 24. The air channels 28 are openings defined through the cushion foam 20. The illustrated cushion foam 20 includes two air channels 28, although only one is visible in FIG. 2. The cushion foam 20 may have any desired number of air channels 28.

The ventilated seat 10 includes an optional B-side air distributer 30 on the cushion B-side 24. A blower 32 is attached to the B-side air distributer 30. The blower 32 is adapted to pull air from the surroundings and push the air into the B-side air distributer 30. The air then flows from the B-side air distributer 30 through the air channel 28 to the cavity 26. The blower 32 may be adapted to operate in a pull mode, if desired. In that case, the blower 32 would pull air from the surroundings on the cushion A-side 22 through the air channel 28 and the B-side air distributer 30 to the blower 32.

The ventilated seat 10 includes an insert 34 that is located in the cavity 26. The insert 34 includes a plurality of air passages 36 that each communicate with the air channel 28 and extend across a ventilated area 38 of the ventilated seat 10. The illustrated air passages 36 extend substantially parallel to the cushion A-side 22, but may have any desired orientation. The insert 34 also includes a cover layer 40 that is located between the air passages 36 and the cushion trim 16. The illustrated cover layer 40 is molded from foam and will be described in greater detail below. A plurality of air distribution holes 42 extend from the air passages 36 through the cover layer 40 and allow air to flow from the air passages 36 to the cushion trim 16. The cushion trim 16 includes perforations (not shown) in the ventilated area 38, which allow the air from the distribution holes 42 to pass through the cushion trim 16. The illustrated ventilated area 38 is located at one end of the seat cushion 12, but may be in any desired location. In the illustrated embodiment, each air passage 36 communicates with one air distribution hole 42. However, the air passages 36 may communicate with any desired number of air distribution holes 42. For example, each air passage 36 may communicate with multiple air distribution holes 42 of varying sizes in order to increase the size of the ventilated area 38.

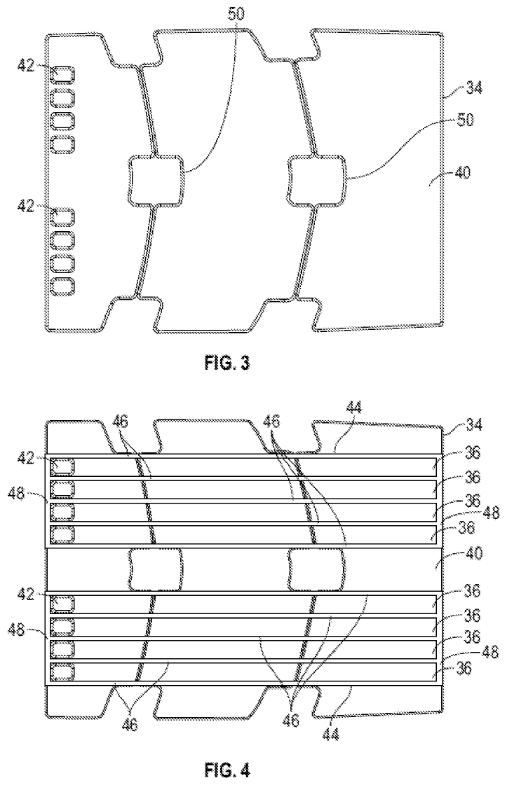

Referring to FIG. 3 there is illustrated a top view of the insert 34, and referring to FIG. 4 there is illustrated a bottom view of the insert 34. The insert 34 includes one or more spacers 44 that are attached to the cover layer 40. The illustrated insert 34 includes two spacers 44, but may include any desired number of spacers 44. The illustrated spacers 44 are made of felt fabric, but may be made of any desired material. Each of the illustrated spacers 44 has a substantially rectangular shape, but may have any desired shape. Each spacer 44 includes a plurality of side walls 46 that define the air passages 36 therebetween. The side walls 46 extend between two end walls 48 located at opposite ends of each spacer 44. In each of the illustrated spacers 44, the air passages 36 extend linearly between the two end walls 48. However, the spacers 44 may have any desired configuration, and the air passages 36 may have any desired shapes, lengths, and orientations.

The insert 34 includes a plurality of openings 50 that cooperate with respective projections 52 (illustrated in FIG. 2) on the cushion foam 20 to properly position the insert 34 on the cushion foam 20 during assembly of the ventilated seat 10. However, the ventilated seat 10 may include any desired positioning aids. The illustrated openings 50 are defined in the cover layer 40, but may be located at any desired part of the insert 34.

When the ventilated seat 10 is assembled, the insert 34 is located in the cavity 26, and the cushion trim 16 is positioned around the cushion foam 20 and the insert 34 in order to retain the insert 34 in position relative to the cushion foam 20. However, the insert 34 may be retained in placed using any desired mechanism. The illustrated cover layer 40 is made of the same foam that the cushion foam 20 is made of. Thus, the ventilated seat 10 provides a uniform feel to an occupant. However, the cover layer 40 may be made of any desired material. Although the illustrated insert 34 is located in the cavity 26, the insert 34 may be any desired size and may, for example, cover the full cushion A-side 22, if desired.

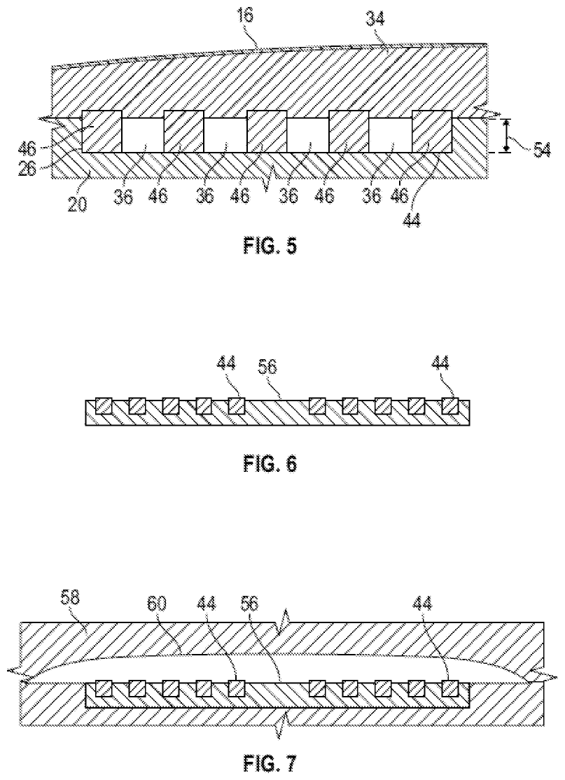

Referring to FIG. 5, there is illustrated a cross-sectional view taken along the line 5-5 of FIG. 4, showing a portion of the seat cushion 12. As previously described, the spacers 44 define the air passages 36. When the occupant is seated on the ventilated seat 10, their weight is distributed by the cover layer 40 onto the spacer 44. The spacer 44 supports the occupant's weight to prevent the air passages 36 from being closed. The air passages 36 define a height 54 that is measured generally perpendicularly to the cushion A-side 22. The spacer 44 is made of a material that compresses less than the cushion foam 20 when subjected to the occupant's weight. As a result, although the height 54 of some of the air passages 36 may decrease when the occupant is seated on the ventilated seat 10, the air passages 36 will remain open under normal loading.

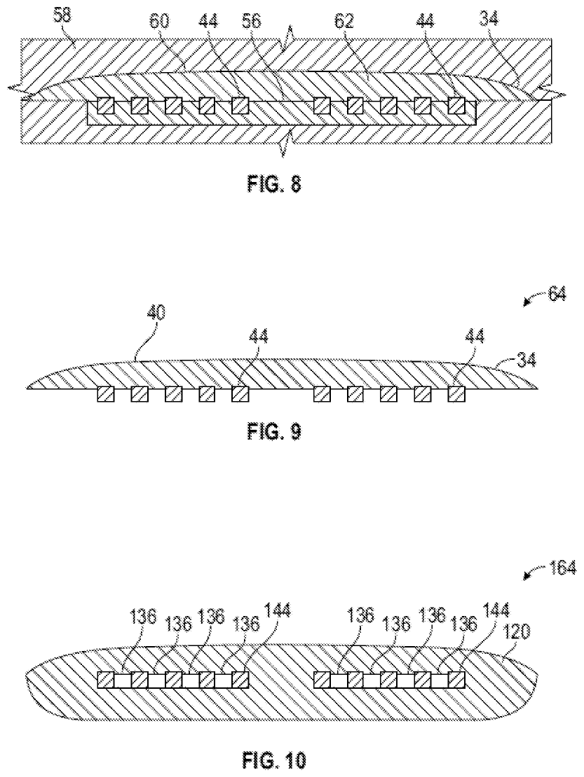

In order to create the insert 34, the cover layer 40 is molded onto the spacers 44. Referring to FIG. 6, there is illustrated a cross-sectional view of the spacers 44 located in a tray 56. This cross-sectional view is taken perpendicular to the air passages 36. The illustrated tray 56 is made of plastic, but may be made of any desired material. Referring to FIG. 7, the spacers 44 and tray 56 are placed in a mold 58, which creates a foam space 60 adjacent to the spacers 44. As shown in FIG. 8, a foam material 62 is injected into the foam space 60 in order to form the cover layer 40 on the spacers 44. In the illustrated embodiment, the foam material 62 is excluded from the air passages 36 during the molding of the insert 34. However, the air passages 36 may be created by any desired method. Referring to FIG. 9, when the foam material 62 solidifies, a foam with integral air passages, indicated generally at 64, is produced. In the illustrated embodiment, the foam with integral air passages 64 is the insert 34.

As previously described, the insert 34 is placed on the cushion foam 20 so that the ventilated seat 10 includes the foam with integrated air passages 64. The air passages 36 distribute air flow across the cushion A-side 22. In the illustrated embodiment, the foam with integral air passages 64 is the insert 34. However, the spacer 44 may be located within the cushion foam 20 so that the foam with integral air passages 64 is the cushion foam 20. In that case, the ventilated seat 10 would not include the insert 34. For example, a multi-shot molding process may be used to apply the foam to opposite sides of the spacer 44 in order to embed the spacer 44 within the cushion foam 20.

Referring to FIG. 10, there is illustrated a cross-sectional view of an alternative foam with integral air passages, indicated generally at 164. The alternative foam with integral air passages 164 includes two spacers 144 that define a plurality of air passages 136. Each spacer 144 is similar to the previously-described spacer 44 and will not be described separately. Also, each air passage 136 is similar to the previously-described air passage 36 and will not be described separately. The alternative foam with integral air passages 164 is a cushion foam 120 that may be used on the ventilated seat 10 in place of the cushion foam 20 and insert 34, if desired.

The insert 34 has been described as part of the seat cushion 12. It should be appreciated that the seat back 14 may also, or alternatively, include air passages 36. The seat back 14 may include an insert 34 or other type of integrated air passages 36, if desired.

The principle and mode of operation of this invention have been explained and illustrated in its preferred embodiments. However, it must be understood that this invention may be practiced otherwise than as specifically explained and illustrated without departing from its spirit or scope.

What is claimed is:

1. A ventilated seat comprising:
a cushion with an air channel extending from a cushion B-side;
a spacer that defines one or more air passages that are connected to the air channel and to one or more air distribution holes on a cushion A-side; and
a cover layer located between the spacer and the cushion A-side, wherein the cover layer is made of a foam material, the spacer is made of a different material, and the cover layer and the spacer are a foam with integrated air passages.

2. The ventilated seat of claim 1, further including a blower that is in fluid communication with the air channel.

3. The ventilated seat of claim 1, wherein the cover layer and the spacer are an insert that is located on the cushion A-side.

4. The ventilated seat of claim 3, wherein the insert includes one or more openings, the cushion includes one or more projections, and each projection is located in one of the openings.

5. The ventilated seat of claim 3, wherein the cushion is made of the foam material.

6. The ventilated seat of claim 3, wherein the air passages extend generally parallel to the cushion A-side between the air channel and the air distribution holes.

7. The ventilated seat of claim 1, wherein the cover layer and the spacer are an insert that is located in a cavity that is located on the cushion A-side.

8. The ventilated seat of claim 7, wherein the insert includes one or more openings, the cushion includes one or more projections, and each projection is located in one of the openings.

9. The ventilated seat of claim 7, wherein the cushion is made of the foam material.

10. The ventilated seat of claim 7, wherein the air passages extend generally parallel to the cushion A-side between the air channel and the air distribution holes.

11. The ventilated seat of claim 1, wherein the cushion is made of the foam material.

12. The ventilated seat of claim 1, wherein the cushion is made of the foam material and the cover layer, the cushion, and the spacer are a foam with integrated air passages.

13. The ventilated seat of claim 12, wherein the air passages extend generally parallel to the cushion A-side between the air channel and the air distribution holes.

14. A method of making a ventilated seat, the method comprising the steps of:
positioning a spacer in a mold to create a foam space adjacent to the spacer, wherein the spacer defines one of more air passages; and
filling the foam space with a foam material to create a foam with integral air passages.

15. The method of making a ventilated seat of claim 14, including the additional step of attaching a blower to an air channel that is in communication with the air passages.

16. The method of making a ventilated seat of claim 14, including the additional step of attaching the foam with integral air passages to a cushion with an air channel extending from a cushion B-side.
